(19) United States
(12) Patent Application Publication
(10) Pub. No.: US 2019/0081427 A1
(43) Pub. Date: Mar. 14, 2019

(54) CONNECTOR

(71) Applicant: Yazaki Corporation, Tokyo (JP)

(72) Inventor: Kazuto OHTAKA, Makinohara-shi (JP)

(73) Assignee: Yazaki Corporation, Tokyo (JP)

(21) Appl. No.: 16/043,770

(22) Filed: Jul. 24, 2018

(30) Foreign Application Priority Data
Sep. 11, 2017 (JP) 2017-173801

(51) Int. Cl. H01R 13/436; H01R 13/74; H01R 24/52; H01R 9/05; H01R 13/11

(52) U.S. Cl. CPC H01R 13/4362; H01R 13/743; H01R 27/02; H01R 9/05; H01R 13/11; H01R 24/52

(57) ABSTRACT

Provide is a connector in which a sub housing and a main housing are used. The connector includes a sub housing, a main housing, and a retainer, and the sub housing is provided with a recess partially recessed from an outer circumferential surface or an extended surface of the outer circumferential surface, the outer circumferential surface having a larger cross section intersecting with an axial direction among a tubular mating sub housing and the sub housing, and the retainer secondarily-locks with an retainer locking portion that is an erect face portion extending in a cross direction intersecting with an axial direction of the sub housing on an inner surface of the recess.

### TECHNICAL FIELD

The present invention relates to a connector in which a terminal is housed in a housing.

### BACKGROUND ART

In addition to a terminal connected to an end portion of the ordinary electric wires among connectors, different kind of terminal such as a terminal connected to an end of an optical fiber cable or a coaxial cable is jointly housed in the housing (see, for example, Patent Document 1 or 2). This type of connector is provided in the housing with an accommodating chamber in which a terminal for electric wire is accommodated, and an accommodating chamber in which a terminal type different from this one is accommodated.

Here, in some of the above-mentioned mixed types of connectors, a sub housing accommodating the different type of terminal is included, and a main housing having an accommodating chamber for an electric wire terminal includes an accommodating chamber for the sub housing (see, for example, Patent Document 3). According to this type of connector, for the different types of terminals which are often subject to change in comparison with terminals for electric wires in general, changing the sub housing can suppress design change of the main housing having the accommodating chamber of the electric wire terminal, and thus can respond to the change.

### PATENT DOCUMENT

### Patent Document 1: Japanese Patent Application Laid-Open No. 2004-039258

### Patent Document 2: Japanese Unexamined Patent Publication No. 2016-072170

### Patent Document 3: Japanese Unexamined Patent Publication No. 2008-226860

### DISCLOSURE OF THE INVENTION

### Problems to be Solved by the Invention

Here, a connector of the type using the sub housing and the main housing as described above requires a structure for fixing the sub housing to the main housing, and as a result, the connector size tends to be large.

Therefore, in view of the above-mentioned problem, it is an object of the present invention to provide a connector using a sub housing and a main housing, the size of which is though suppressed.

### Means for Solving the Problems

In order to solve the above problem, the connector of the present invention includes a first terminal; a second terminal having a terminal type different from that of the first terminal; a cylindrical sub housing configured to accommodate and lock the second terminal; a main housing provided with at least one of a first accommodating chamber configured to accommodate and primarily-lock one first terminal and at least one of a second accommodating chamber configured to accommodate and primarily-lock one sub housing; and a retainer configured to be individually and in a manner avoiding falling-off attached to and secondarily-locked with the main housing, the first terminal housed in the first accommodating chamber and the sub housing accommodated in the second accommodating chamber, the sub housing is provided with a recess partially recessed from an outer circumferential surface or an extended surface of the outer circumferential surface, the outer circumferential surface having a larger cross section intersecting with an axial direction thereof among a tubular mating sub housing accommodating and locking a mating terminal to be connected with the second terminal and the sub housing, and the retainer secondarily-locks with an erect face portion on an inner surface of the recess, the erect face portion extending in a cross direction intersecting with the axial direction of the sub housing.

### Advantages of the Invention

In the connector of the present invention, the erect face portion on the inner surface of the recess partially recessed from the outer circumferential surface or the extended surface of the outer circumferential surface, the outer circumferential surface having a larger cross section intersecting with the axial direction thereof among the tubular mating sub and the sub housing as a portion the retainer secondarily-locks is used. The second accommodating chamber of the main housing needs a surface for joining the second terminal and the mating terminal, but this size corresponds to the cross section of the larger one among the mating sub housing and the sub housing. Since the abovementioned recess corresponds to the portion partially recessed from the outer circumferential surface having a larger cross section or the extended surface, the abovementioned erected portion will be settled within the required space for joining the second terminal in the second accommodating chamber and the mating terminal. That is, there is no need to newly expand a space inside the main housing in order for the retainer to secondarily-lock, suppressing size on the main housing side from increasing in this secondarily-locking structure. Thus, according to the present invention, it is possible, while using the sub housing and the main housing to reduce the burden of designing and manufacturing, to suppress the increase in size of the connector.

### BRIEF DESCRIPTION OF THE DRAWINGS

FIG. 1 is a view showing a connector according to an embodiment of the present invention;

FIG. 2 is an exploded view of the connector shown in FIG. 1;

FIG. 3 is a schematic view for explaining an assembling procedure of a male connector;

FIG. 4 is a view illustrating of accommodation of a crimp terminal into a first accommodating chamber and primary locking, and accommodation of a sub housing to a second accommodating chamber and primary locking, for a main housing in which a retainer is inserted to the temporarily-locked state;

FIG. 5 is an appearance perspective view of the sub housing shown in FIG. 3;

FIG. 6 is a view of a front view of the sub housing shown in FIG. 5, viewed from a direction of an arrow V11 in the drawing, a side view seen from a direction of an arrow V12, and a cross-sectional view taken along a line V13-V13;

FIG. 7 is a view illustrating a positional relationship between a retainer locking portion in the sub housing shown in FIGS. 5 and 6 and a retainer temporarily locked with the main housing;

FIG. 8 is a view illustrating a positional relationship between a retainer locking portion in the sub housing shown in FIGS. 5 and 6 and a retainer finally locked with the main housing;

FIG. 9 is a schematic diagram for explaining a procedure for assembling a female connector;

FIG. 10 is a view illustrating of accommodation of a crimp terminal into a first accommodating chamber and primary locking to a main housing in which a retainer is inserted to the temporarily-locked state, and accommodation of a sub accommodating chamber to a second accommodating chamber and primary locking;

FIG. 11 is an appearance perspective view of the sub housing shown in FIG. 9;

FIG. 12 is a view of a front view of the sub housing shown in FIG. 11, viewed from a direction of an arrow V21 in the drawing, a side view seen from a direction of an arrow V22, and a cross-sectional view taken along a line V23-V23;

FIG. 13 is a view illustrating a positional relationship between the retainer locking portion in the sub housing shown in FIGS. 11 and 12 and the retainer temporarily locked with the main housing;

FIG. 14 is a view illustrating a positional relationship between the retainer locking portion in the sub housing shown in FIGS. 11 and 12 and the retainer temporarily locked with the main housing; and

FIG. 15 is a view showing a series of steps from a state in which a communication terminal is fixed to an end portion of a coaxial cable to a state in which this communication terminal is accommodated in and locked with the sub housing.

### DETAILED DESCRIPTION OF THE INVENTION

Hereinafter, an embodiment of a connector of the present invention will be described.

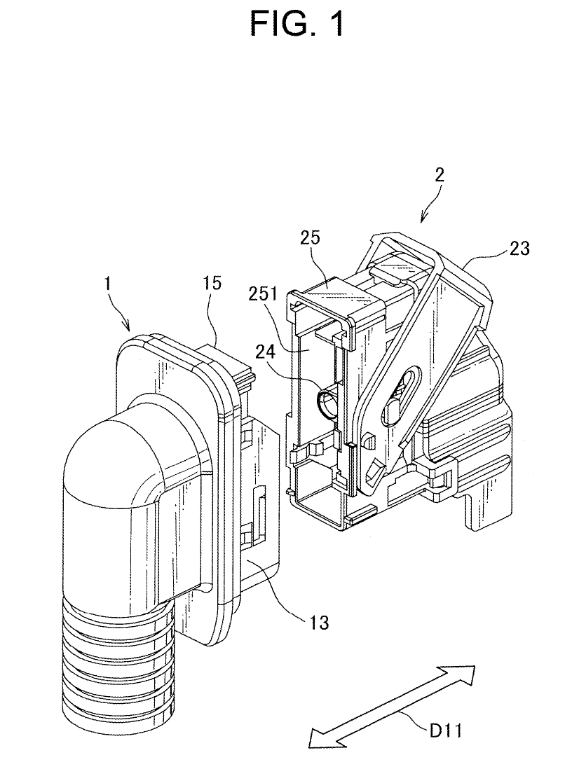

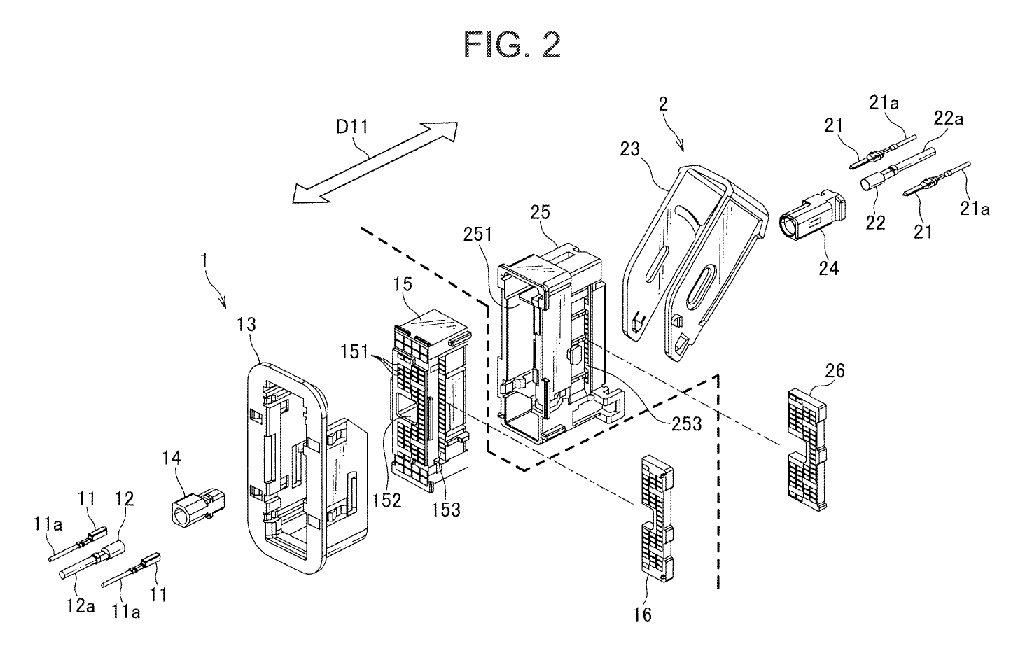

FIG. 1 shows a connector according to an embodiment of the present invention, and FIG. 2 shows an exploded view of the connector shown in FIG. 1.

FIGS. 1 and 2 show a female connector 1 and a male connector 2 which are fitted to each other. Both of these two connectors 1 and 2 correspond to the connector according to one embodiment of the present invention.

These two connectors 1 and 2 are lever-lock-type connectors. The female type of connector 1 is fixed to an object to be mounted such as a door frame of a vehicle, and the male type of connector 2 is fitted to this female connector 1.

The female connector 1 is mixed-type connector which includes a female crimp terminal 11 (first terminal) which is connected to a covered electrical wire 11a, and female communication terminal 12 (second terminal) which is connected to a coaxial cable 12a for communication and which is different from the crimp terminal 11. And this connector 1 includes a frame 13, a sub housing 14, a main housing 15, and a retainer 16. The frame 13 is fixed to an attachment object such as a door frame. The sub housing 14 is formed in a cylindrical shape and accommodates and locks the communication terminal 12 therein. The main housing 15 is formed in a substantially rectangular shape and fixed to the frame 13.

A plurality of first accommodating chambers 151 that accommodates and primarily-locks one crimp terminal 11 is provided in the main housing 15, and one second accommodating chamber 152 that accommodates and primary locks one sub housing 14. The first accommodating chamber 151 and the second accommodating chamber 152 are tubular portions in which two connectors 1 and 2 pass through the main housing 15 along a fitting direction D11 and are disposed in parallel with each other. The first accommodating chamber 151 and the second accommodating chamber 152 have the crimp terminal 11 or the sub housing 14 accommodating the communication terminal 12 inserted therein from one side of an opening.

The main housing 15 is provided with an insertion hole 153 for a retainer 16 that is to be mentioned later. The insertion hole 153 is provided across the first accommodating chamber 151 and the second accommodating chamber 152, and the retainer 16 also traverses the first accommodating chamber 151 and the second accommodating chamber 152 so as to be inserted and attached to the insertion hole 153. The retainer 16 is attached to the main housing 15, and individually and in such a manner as not to fall off secondarily-locks both the crimp terminal 11 accommodated in the first accommodating chamber 151 and the sub housings 14 accommodated in the second accommodating chamber 152.

The male type connector 2 is also a mixed type connector that includes a male type crimp terminal 21 connected to the covered electric wire 21a, a male type communication terminal 22 which is different from the crimp terminal 21 and is connected to the coaxial cable 22a for communication. The connector 2 is provided with a lock lever 23, a sub housing 24, a main housing 25, and a retainer 26. The lock lever 23 is rotatably attached to the main housing 25, and rotates when the two connectors 1 and 2 are engaged so as to assist fitting of these two connectors 1 and 2 and locks the two connectors 1 and 2 so that they will not come off after mating. The sub housing 24 is formed in a tubular shape to accommodate and lock the communication terminal 22. The main housing 25 is provided with a substantially rectangular recess 251 into which the main housing 15 of the female connector 1 is fitted.

From the bottom of the recess 251 in the main housing 25 toward the opposite side to a fitting side with the female connector 1, as hidden in FIG. 2, the first accommodating chamber and the second accommodating chamber which are tubular pass through the housing 25 and extend parallel to each other. The first accommodating chamber and the second accommodating chamber have the crimp terminal 21 or the sub housing accommodating the communication terminal 22 inserted therethrough from an opening on the side opposite to the fitting side.

The main housing 25 is also provided with an insertion hole 253 for the retainer 26. The insertion hole 253 is also provided across the first accommodating chamber and the second accommodating chamber, the retainer 26 is also inserted into the insertion hole 253 and is attached in such a manner to traverse the first accommodating chamber and the second accommodating chamber. The retainer 26 is attached to the main housing 25, and individually and in a manner not to fall off secondarily-locks both the crimp terminal 21 accommodated in the first accommodating chamber and the sub housing 24 accommodated in the second accommodation chamber.

Next, an assembling procedure of the female connector 1 and the male connector 2 will be described while appropriately exposing a locking structure of the crimp terminals 11 and 21 or the communication terminals 12 and 22 by means of the sub housings 14, 24, the main housings 15, 25, and the retainers 16, 26. First, the male connector 2 will be described.

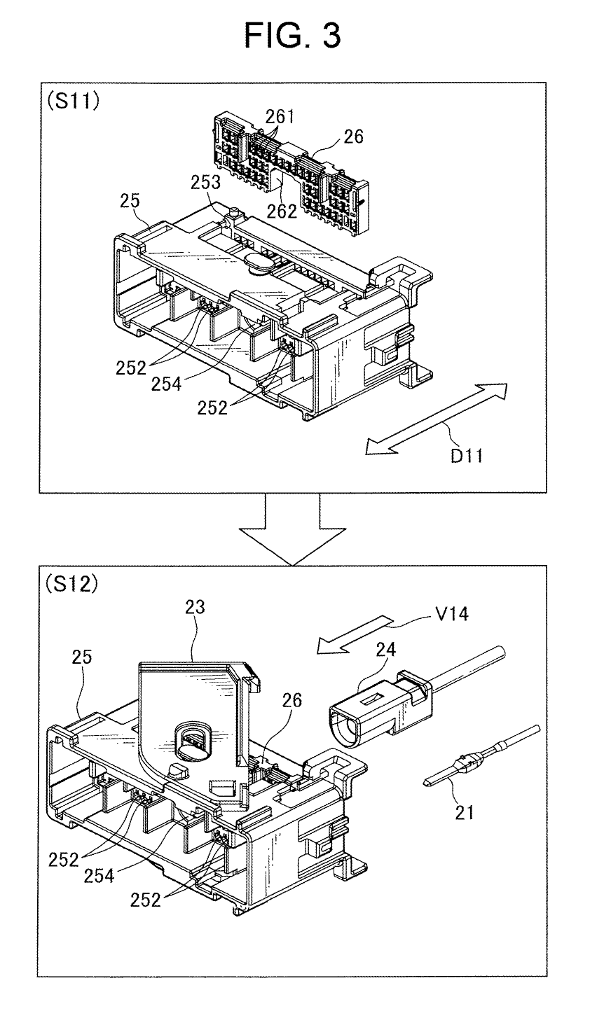

FIG. 3 is a schematic view for explaining an assembling procedure of the male type connector.

In the assembling procedure shown in FIG. 3, the retainer 26 is first attached to the main housing 25 (Step S11).

As described above, the main housing 25 is provided with the first accommodating chamber plurally arranged that individually accommodates and primarily-locks the crimp terminal 21, and one second accommodating chamber 254 that accommodates and primarily-locks the sub housing 24. The first accommodating chamber 252 and the second accommodating chamber 254 are provided in parallel with each other through the main housing 25 along the fitting direction D11, and the second accommodating chamber 254 is provided substantially at the center of the lattice-like arrangement of the first accommodating chambers 252. The insertion hole 253 of the retainer 26 is disposed crossing the first accommodating chamber 252 and the second accommodating chamber 254, and the retainer 26 is also inserted into the insertion hole 253 so as to cross the first accommodating chamber 251 and the second accommodating chamber 254 to be attached.

Here, as will be described later, in the present embodiment, the retainer 26 is inserted into the insertion hole 253 in two stages of the temporarily-locked state and the fully-locked state. The retainer 26 is provided with a plurality of communication holes 261 and one communication groove 262. Despite the position of the retainer 26 between the temporarily-locked state and the fully-locked state, the plurality of communicating holes 261 communicate with the plurality of first accommodating chambers 252 one by one and the communication groove 262 communicates with the second accommodating chamber 254. In step S11 of FIG. 3, the retainer 26 is inserted into the insertion hole 253 until reaching temporarily-locked state.

In the following step S12, the lock lever 23 is attached to the main housing 25. Further, the crimp terminal 21 is accommodated and primarily-locked in the first accommodating chamber 252, and the sub housing accommodating the communication terminal 22 is accommodated and primarily-locked in the second accommodating chamber 254. And the retainer 26 is inserted to the fully-locked state after accommodation, the crimp terminal 21 and the sub housing 24 are thus secondarily-locked in such a manner not to be detached from the first accommodating chamber 252 and the second accommodating chamber 254, respectively. The temporarily-locked state and the fully-locked state of the retainer 26 will be explained again later, but a temporary locking of the crimp terminal 21 and the sub housing 24 when the retainer 26 is temporarily locked will be first described.

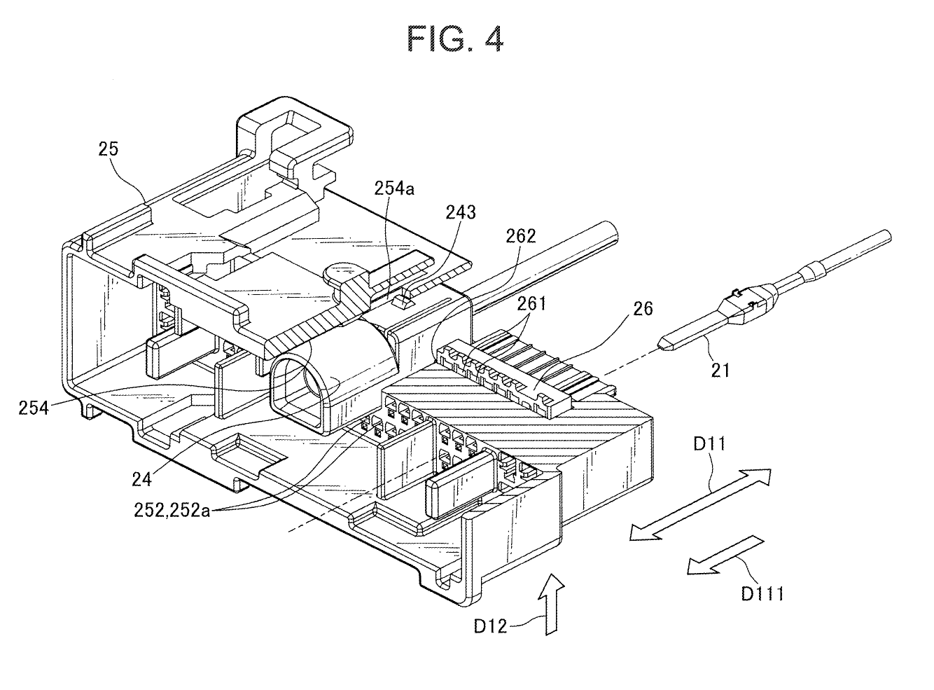

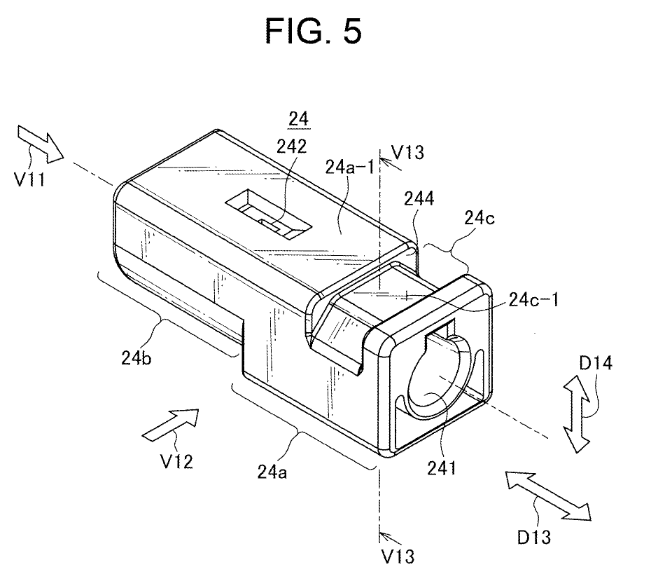

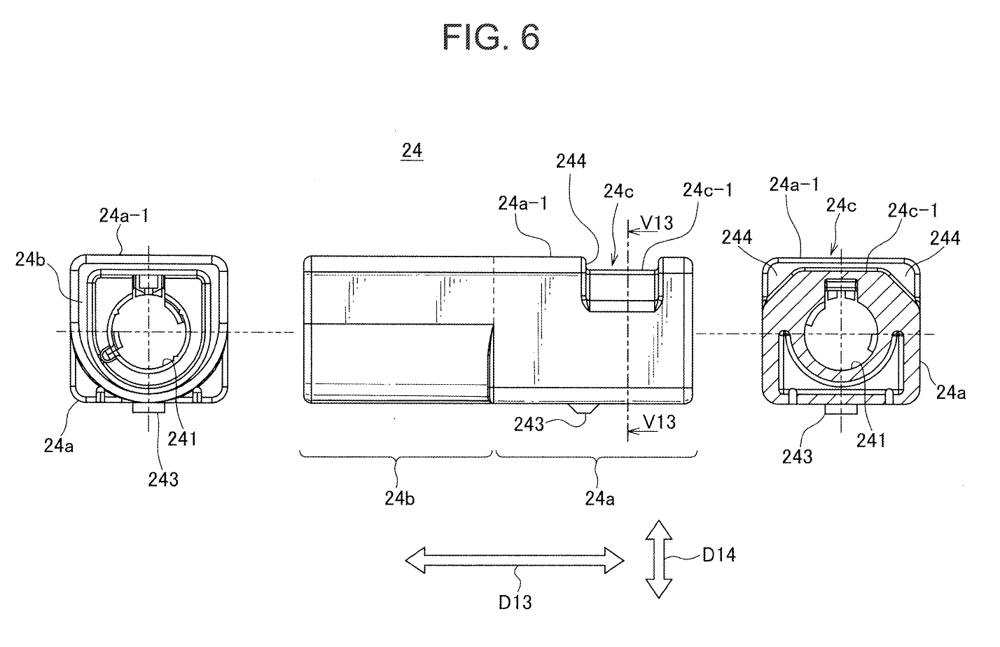

FIG. 4 is a view illustrating of accommodating the crimped terminal into the first accommodating chamber and primarily-locking, and accommodating the sub housing in the second accommodating chamber and primarily-locking, for the main housing in which the retainer is inserted to the temporarily-locked state. FIG. 5 is an appearance perspective view of the sub housing shown in FIG. 3, FIG. 6 is a view of a front view of the sub housing shown in FIG. 5, viewed from a direction of an arrow V11 in the drawing, a side view seen from a direction of an arrow V12, and a cross-sectional view taken along a line V13-V13. In FIG. 4, the lock lever 23 is omitted, and the main housing 25 is shown in a state of being turned upside down to FIG. 3. Also, in FIG. 4, a part of the main housing 25 is cut so that the first accommodating chamber 252 and the second accommodating chamber 254 can be seen.

The retainer 26 is inserted into the insertion hole 253 (see FIG. 3) crossing the first accommodating chamber 252 and the second accommodating chamber 254 in an insertion direction D12. At this time, the temporarily-locked state of the retainer 26 is a state of insertion of the retainer 26 into the insertion hole 253 where the crimp terminal 21 is allowed to be accommodated in the first accommodating chamber 252 and the sub housing 24 is allowed to be accommodated in the second accommodating chamber 254. Following this temporarily-locked state, when the retainer 26 is inserted to the fully-locked state, the crimp terminal 21 and the sub housing 24 is secondarily-locked, so as not to substantially move inside the first accommodating chamber 252 and the second accommodating chamber 254.

In this temporarily-locked state, the communication hole 261 and the communication groove 262 of the retainer 26 communicate with the first accommodating chamber 252 and the second accommodating chamber 254 of the housing 25, respectively. The crimp terminal 21 is inserted through the communication hole 261, and accommodated in the first accommodation chamber 252. Inside the first accommodating chamber 252, a lance 252a is provided for locking the crimping terminal 21 when the crimp terminal 21 is inserted into the first accommodating chamber 252. The crimp terminal 21 is primarily-locked inside the first accommodating chamber 252 by the lance 252a.

Further, in the temporarily-locked state, the sub housing 24 passes through the communication groove 262 and is inserted into the second accommodating chamber 254 and accommodated therein. Here, as shown in FIG. 4, the second accommodating chamber 254 is provided with a locking hole 254a into which the projecting housing locking portion 243 provided in the sub housing 24 fits. When the sub housing 24 is inserted into the second accommodating chamber 254, the housing locking portion 243 is fitted into the locking hole 254a. By this fitting the sub housing 24 is primarily-locked inside the second accommodating chamber 254.

Here, the housing locking portion 243, while deforming so as to sink temporarily, fits in the locking hole 254a in the second accommodating chamber 254. The locking hole 254a is formed larger than the housing locking portion 243 in an accommodating direction D111 of the housing 24 along the fitting direction D11 in order to secure an over stroke to allow such deformation. Further to such a size difference, in addition to a component manufacturing tolerance in the sub housing 24 and the main housing 25, locking of the housing locking portion 243 to the locking hole 254a allows play to the extent. That is, the sub housing 24 is primarily-locked in the second accommodating chamber 254 of the main housing 25 while permitting backlash in the accommodating direction D111.

The sub housing 24 is made of resin and formed in a tubular shape, and the coaxial cable 22a (FIG. 2) is passed inside the through hole 241, and the communication terminal 22 (FIG. 2) is accommodated. In the present embodiment, the male-type sub housing 24 has a cylindrical portion 24a formed in a rectangle block-shaped a side on which the coaxial cable 22a extends and a cylindrical portion 24b formed in semicylindrical a side on which the communication terminal 22 is accommodated.

As will be described later, the communication terminal 22 is provided with a projecting end for engaging with the sub housing 24. In the sub housing 24 provided is a hole-like communication terminal locking portion 242 to be engaged with the terminal side locking portion by the terminal side locking portion being fitted into, on a cylinder portion 24b formed in a semicylindrical shape. In addition, in the sub housing 24 provided is the described housing locking portion 243 for primarily engaging with the main housing 25 in the rectangular block-shaped cylindrical portion 24a. Further, the sub housing 24 has a retainer locking portion 244 for secondarily-locking with the retainer 26 provided in the rectangular block-shaped cylindrical portion 24a.

The male-type sub housing 24 is aligned with the female sub housing 14 to become the mating sub housing in the axial direction D13 when connecting with the communication terminal 12 of the female type that is a mating side terminal with the male type communication terminal 22 (FIG. 2). Further, in the present embodiment, at the time of this connection, a part of the male type sub housing 14 is configured to enter the cylindrical portion 24b in the female type sub housing 24. Because of that relationship, the male type sub housing 24 has a larger cross section crossing the axial direction D13 than that of the female type sub housing 14.

In the present embodiment, the rectangular block-shaped cylindrical portion 24a in the male type sub housing 24 having a large cross section as described above is provided with a recess 24c partially recessed in a groove shape from the outer peripheral surface 24a-1. An erect face portion extending in the intersecting direction D14 with respect to the axial direction D13 of the sub housing 24 on the inner surface 24c-1 of the recess 24c serves as a retainer locking portion 244 for secondarily-locking the retainer 26.

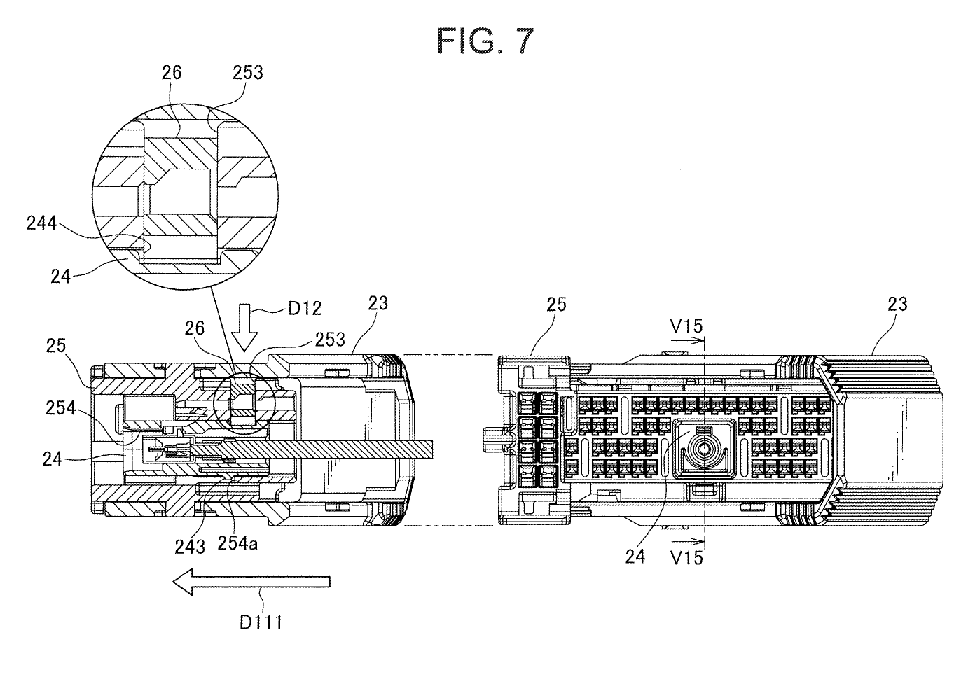

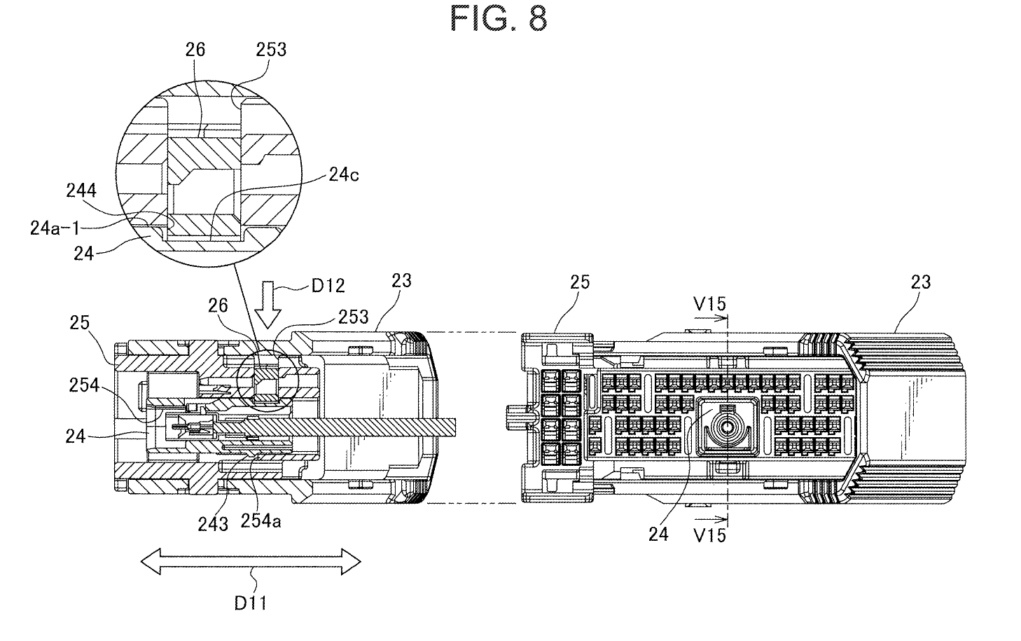

FIG. 7 is a view illustrating the positional relationship between the retainer locking portion in the sub housing shown in FIGS. 5 and 6 and the retainer temporarily-locked with the main housing, and FIG. 8 is a view illustrating the positional relationship between the retainer locking portion in the sub housing shown in FIGS. 5 and 6 and the retainer finally-locked with the main housing.

FIGS. 7 and 8 illustrate plan views where the lock lever 23 is attached as shown in FIG. 3, the retainer 26 is temporarily locked, and the main housing 25 accommodating the sub housing 24 is viewed from the direction of the arrow V14 in FIG. 3. Also, on the left side of this plan view, a sectional view taken along the line V15-V15 in the figure is shown. In these FIGS. 7 and 8, the crimp terminal 21 is omitted from the illustration.

As shown in FIG. 7, when the retainer 26 is inserted into the insertion hole 253 of the main housing 25 in the direction of the arrow D12 and is in the temporal locked state, the retainer 26 is separated from the retainer locking portion 244 in the sub housing 24. As a result, the sub housing 24 can be accommodated in the second accommodating chamber 254 of the main housing 25 in the accommodating direction D111. The sub housing 24, as described above, is accommodated in the second accommodating chamber 254 until the housing locking portion 243 is primarily-locked with the locking hole 254a of the housing 25 in a state where backlash is permitted.

Then, as shown in FIG. 8, when the retainer 26 is further inserted into the insertion hole 253 of the main housing 25 in the direction of the arrow D12 to be in the fully-locked state, the retainer 26 is secondarily-locked with the retainer locking portion 244 in the second position 24. At this time, the retainer 26 is fitted into the recessed portion 24c in the outer peripheral surface 24a-1 of the sub housing 24. As a result, the sub housing 24 is immovable in the fitting direction D11. Also, at this time, the retainer 26 is also secondarily-locked with the crimp terminal 21 so that the crimp terminal 21 also becomes immovable in the fitting direction D11.

Here, as described above, at the stage where the retainer 26 is temporarily-locked in the second accommodating chamber 254 of the housing 25, the sub housing 24 is primarily-locked while permitting backlash in the accommodating direction D111. On the other hand, when the retainer 26 is pushed to the fully-locked state and is to be locked on the retainer locking portion 244, the retainer 26 is locked while pushing in the accommodating direction D 111. As a result, the sub housing 24 is pushed out in the accommodating direction D111. As a result, with respect to the accommodation direction D111, the housing locking portion 243 is pressed against the edge of the locking hole 254a. By this pressing, the backlash is suppressed in an assembly of the main housing 25 and the sub housing 24 at the temporarily-locked state of the retainer 26.

Next, the assembly procedure of the female connector 1 shown in FIGS. 1 and 2 will be described.

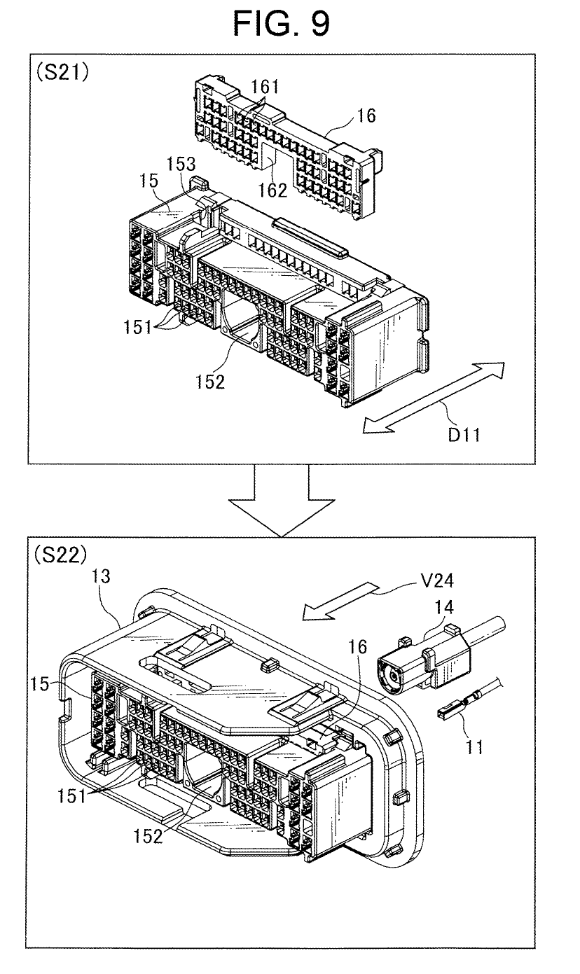

FIG. 9 is a schematic view for explaining the assembling procedure of the female connector.

The retainer 16 is attached to the main housing 15 in the assembling procedure shown in FIG. 9 (Step S21).

Even in the female connector 1, the main housing 15 is provided with a plurality of first accommodating chambers 151 arranged that individually accommodates and primarily-locks the crimp terminal 11, and one sub housing 14 that accommodates and primarily-locks one second accommodating chamber 152. The first accommodating chamber 151 and the second accommodating chamber 152 penetrate the main housing 15 along the fitting direction D11 and are disposed parallel to each other, and the second accommodating chamber 152 is provided substantially at the center of the lattice-like arrangement of the first accommodating chamber 151. Further, the insertion hole 153 of the retainer 16 is disposed crossing the first accommodating chamber 151 and the second accommodating chamber 152, and the retainer 16 is also inserted into and attached to the insertion hole 153 in such a manner as to cross the first accommodating chamber 251 and the second accommodating chamber 152.

Here, as will be described later, in the present embodiment, the retainer 16 is inserted into the insertion hole 153 in two stages of the temporarily-locked state and the fully-locked state. The retainer 16 is provided with a plurality of communication holes 161 and one communication groove 162. Even in the case that the retainer 16 is positioned between the temporarily-locked state and the fully-locked state, the plurality of communicating holes 161 communicates with the plurality of first accommodating chambers 151 one by one, and the communication groove 162 communicates with the second accommodating chamber 152. In step S21 of FIG. 9, the retainer 16 is inserted into the insertion hole 153 until reaching the temporarily-locked state.

In the following step S 22, the frame 13 is attached to the main housing 15. Furthermore, the crimp terminal 11 is accommodated and primarily-locked in the first accommodating chamber 151, and the sub housing 14 having accommodated the communication terminal 12 is accommodated and primarily-locked in the second accommodation chamber 152. Then, insertion of the retainer 16 to the fully-locked state after accommodation makes the crimp terminal 11 and the sub-housing 14 secondarily-locked so that they cannot drop off from the first accommodating chamber 151 and the second accommodating chamber 152, respectively. The temporarily-locked state and the fully-locked state of the retainer 16 will be explained again later. Temporary locking of the crimp terminal 11 and the sub housing 14 which are to be carried out when the retainer 16 is in the primarily-locked state will be described.

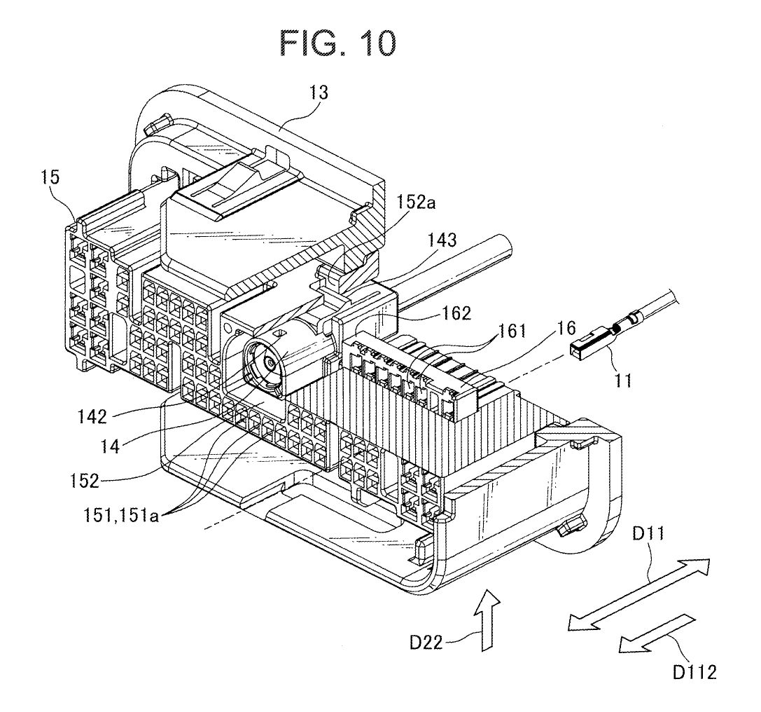

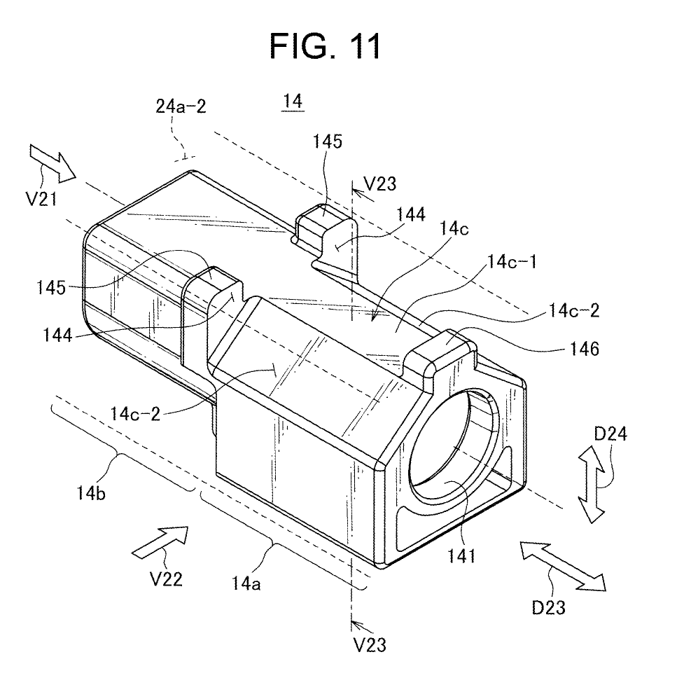

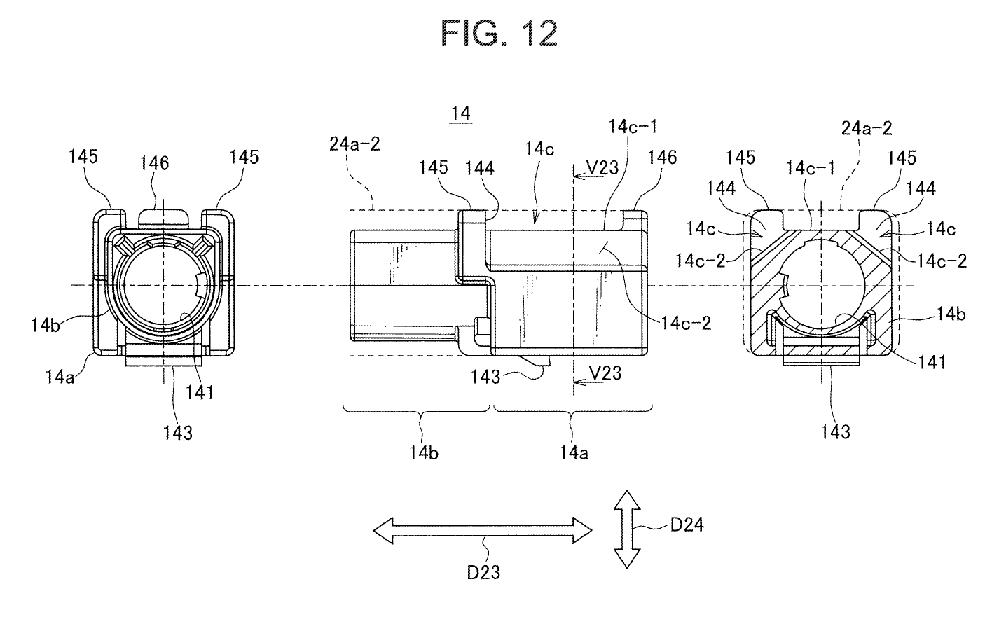

FIG. 10 is a view illustrating of accommodation and primary locking of the crimp terminal into the first accommodating chamber with respect to the main housing in which the retainer is inserted reaching the temporarily-locked state, and accommodation and primary locking of the sub housing to the second accommodating chamber. FIG. 11 is an appearance perspective view of the sub housing shown in FIG. 9. FIG. 12 is a view of a front view of the sub housing shown in FIG. 11, viewed from the direction of the arrow V21 in the drawing, a side view seen from the direction of the arrow V22, and a cross-sectional view taken along the line V23-V23. Note that in FIG. 10, the main housing 15 is shown in a state of being turned upside down together with the frame 13. Also, in FIG. 10, a part of the main housing 15 is shown in a cut state as the first accommodating chamber 151 and the second accommodating chamber 152 can be seen.

The retainer 16 is inserted to the insertion hole 153 (FIG. 9) in the insertion direction D22 crossing the first accommodating chamber 151 and the second accommodating chamber 152. At this time, the temporarily-locked state of the retainer 16 means a state of insertion of the retainer 16 into the insertion hole 153 in which the crimp terminal 11 is allowed to be accommodated in the first accommodating chamber 151, and the sub housing 14 is allowed to be accommodated in the second accommodating chamber 152. When the retainer 16 is inserted to the fully-locked state following this temporarily-locked state, the crimp terminal 11 and the sub housing 14 are secondarily-locked so as not substantially move inside the first accommodating chamber 151 or the second accommodating chamber 152.

In this temporarily-locked state, the communication hole 161 and the communication groove 162 of the retainer 16 communicate with the first accommodating chamber 151 and the second accommodating chamber 152 of the housing 15, respectively. The crimp terminal 11 is inserted into and accommodated in the first accommodating chamber 151 passing the communication hole 161. The first accommodating chamber 151 is provided with a lance 151a therein locking the crimp terminal 11 when the crimp terminal 11 is inserted into the first accommodation chamber 151. The crimp terminal 11 is primarily-locked by the lance 151a inside the first accommodating chamber 151.

Further, in the temporarily-locked state, the sub housing 14 passes through the communicating groove 162 and is inserted and accommodated in the second accommodating chamber 152. Here, as shown in FIG. 10, the second accommodating chamber 152 is provided with a locking hole 152a with which a projecting housing locking portion 143 provided in the sub housing 14 is engaged. When the sub housing 14 is inserted into the second accommodating chamber 152, the housing locking portion 143 is fitted into the locking hole 152a. This fitting makes the sub housing 14 primarily-locked inside the second accommodating chamber 152.

Here, the housing locking portion 143, while deforming to sink temporarily, fits in the locking hole 152a in the second accommodating chamber 152. The locking hole 152a is formed to be larger than the housing locking portion 143 in the accommodating direction D112 of the housing 14 along the abovementioned fitting direction D11 in order to secure an over stroke for allowing this deformation. Adding a component manufacturing tolerance to such a size difference in the sub housing 14 and the main housing 15, the locking of the housing locking portion 143 to the locking hole 152a allows play to the extent. That is, also in female connector 1, the sub housing 14, while allowing play in the accommodating direction D112, is primarily-locked in the second accommodating chamber 152 of the housing 15.

The sub housing 14 is made of resin and formed into a tubular shape, and the coaxial cable 12a (FIG. 1) is passed inside the through hole 141, and the communication terminal 12 (FIG. 1) is accommodated. In the present embodiment, the male-type sub housing 14 is made such that a side on which the coaxial cable 12a extends and exits is the rectangular block-like tubular portion 14a, a side on which the communication terminal 12 is accommodated is a semicylindrical tubular portion 14b.

As will be described later, the communication terminal 12 is provided with a projecting terminal side locking portion for engaging with the sub housing 14. As shown in FIG. 10, in the sub housing 14, a hole-like communication terminal locking portion 142 that engages with the terminal side locking portion by fitting the terminal side locking portion is provided in the cylindrical part 14b of a semicylindrical shape. In addition, in this sub housing 14, the abovementioned housing locking portion 143 for primarily-locking with the main housing 15 is provided. Further, the sub housing 14 is provided with a retainer locking portion 144 for secondarily-locking with the retainer 16 at the boundary with the rectangular block-like tubular portion 14a and the semicylindrical tubular portion 14b.

Here, the female sub housing 14 is configured such that a part of the semicylindrical tubular portion 14b enters the semicylindrical tubular portion 24b of the male sub housing 24 that is the mating sub housing. For that reason, the female sub housing 14 has a narrower cross section crossing the axial direction D23 than that of the male sub housing 24.

In the present embodiment, the rectangular block-like tubular portion 14a in the female sub housing 14 having the narrow section as described above is provided with a recess 14c partially recessed from the extended surface 24a-2 of an outer peripheral surface 24a-1 of the male-type sub housing 24 having a wide cross section. And an erect face portion extending in the direction D24 intersecting the axial direction D23 of the sub housing 14 on an inner surface 14c-1 of the recess portion 14c is a retainer locking portion 144 for secondarily-locking with the retainer 16.

In this female sub housing 14, a chamfered portion 14 c-2 is formed at two corners along the axial direction D23 on the upper side in FIG. 11 in the rectangular block-like tubular portion 14a. The retainer locking portion 144 is an erected surface portion facing the chamfered portion 14c-2 on the two projections 145 that protrudes from the two chamfered portions 14c-2 to the above-mentioned extension surface 24a-2. Further, on the extension side of the coaxial cable 12a in the rectangular block-like tubular portion 14a, one protrusion 146 protruding into the extension surface 24a-2 is provided between two chamfered portions 14c-2.

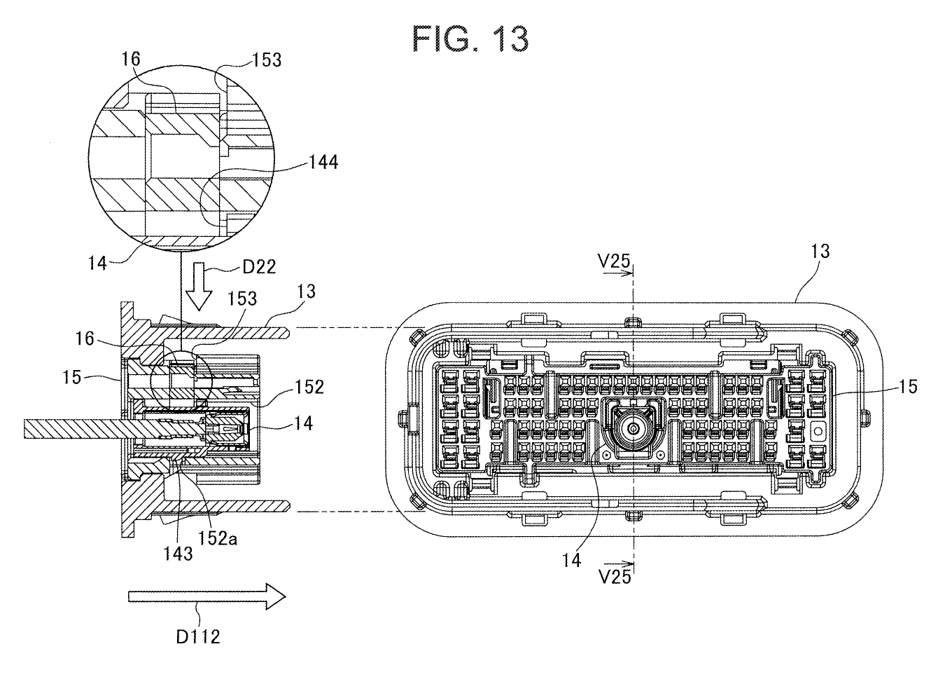

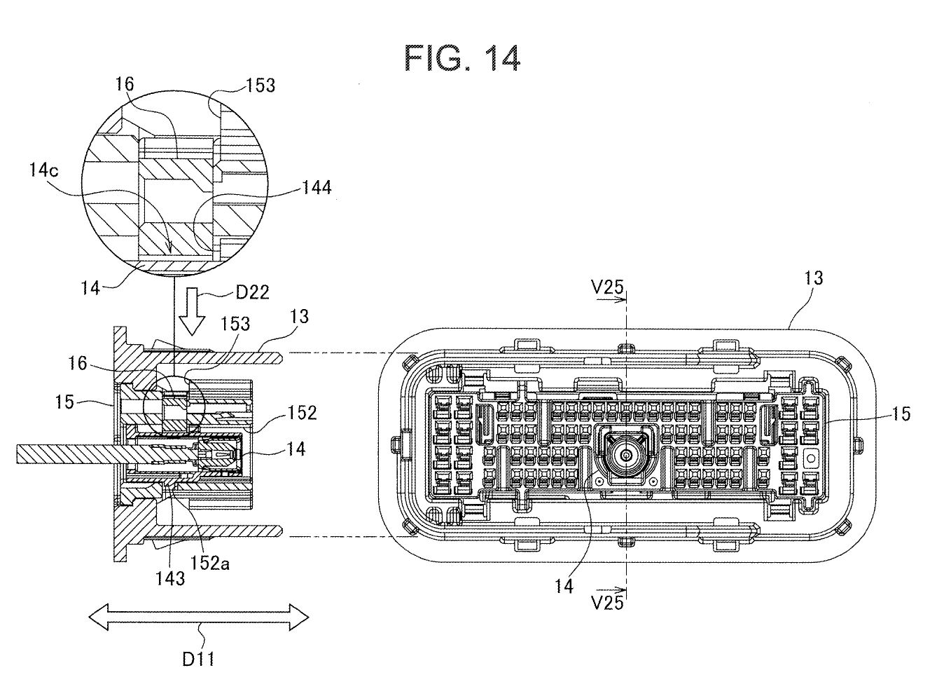

FIG. 13 is a view illustrating the positional relationship between the retainer locking portion in the sub housing shown in FIGS. 11 and 12 and the retainer is temporarily-locked with the main housing, FIG. 14 is a view illustrating the positional relationship between the retainer locking portion in the sub housing shown in FIGS. 11 and 12 and the retainer temporarily-locked with the main housing.

FIGS. 13 and 14 illustrate plan views where the retainer 16 to which the frame 13 is attached is temporarily-locked, the main housing 15 accommodating the bush housing 14 is seen from the direction of the arrow V24 in FIG. 9. Also, on the left side of the plan view, a cross-sectional view along V25-V25 line is shown. These FIGS. 13 and 14 omit the crimp terminal 11.

As shown in FIG. 13, when the retainer 16 is inserted into the insertion hole 153 of the main housing 15 in the direction of the arrow D22 so as to be in the temporarily-locked state, the retainer 16 is separated from the retainer locking portion 144 of the sub housing 14. As a result, the sub housing 14 becomes capable of being accommodated in the second accommodating chamber 152 of the main housing 15 in the accommodating direction D112. The sub housing 14 is accommodated in the second accommodating chamber 152 until the housing locking portion 143 is temporarily-locked with the locking hole 152a of the second housing 15 where backlash is permitted as described above.

Then, as shown in FIG. 14, when the retainer 16 is inserted into the insertion hole 153 of the main housing 15 in the direction of the arrow D22 so as to be in the fully-locked state, the retainer 16 secondly-locks the retainer locking portion 144 of the sub housing 14. At this time, the retainer 16 is fitted into the recess 14c of the sub housing 14. As a result, the sub housing 14, together with the engagement with the locking hole 152a of the housing locking portion 143 becomes immovable in the fitting direction D11. Further, at this time, the retainer 16 is also secondarily-locked with the crimp terminal 11, and the crimp terminal 11 also becomes immovable in the fitting direction D11.

Here, as described above, at the stage where the retainer 16 is temporarily-locked, the sub housing 14 is primarily-locked with the second accommodating chamber 152 of the housing 15 where a backlash is allowed in the accommodation direction D111. On the other hand, when the retainer 16 is pushed to the fully-locked state and locks with the retainer locking portion 144, the retainer 16 is locked while pushing the retainer locking portion 144 in the direction D 111. As a result, the sub housing 14 is pushed out in the direction D111. As a result, the housing locking portion 143 is pressed against an edge of the locking hole 152a in the accommodation direction D111. This pressing suppresses the backlash at the stage where the main housing 15 and the sub housing 14 are assembled.

Next, the procedure for attaching the communication terminals 12, 22 to the sub housings 14, 24 will be described as an example, taking one example of the attachment of the communication terminal 12 to the female sub housing 14. The attachment of the communication terminal 22 to the male type sub housing 24 is also performed in substantially the same procedure.

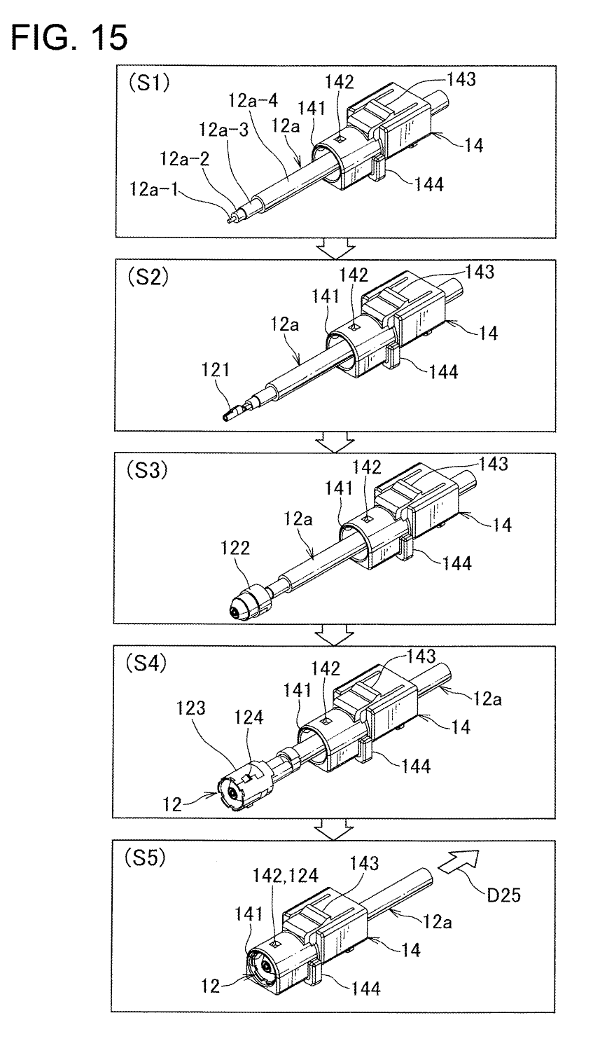

FIG. 15 is the view showing the series of steps from a state in which the communication terminal is fixed to the end portion of the coaxial cable to the state in which this communication terminal is accommodated and locked in the sub housing. The sub housing 14 is shown in FIG. 15 in the same orientation as FIG. 15.

The sub housing 14 is made of resin and formed into a tubular shape, and the coaxial cable 12a is inserted inside the through hole 141, and the communication terminal 12 is accommodated. The communication terminal 12 is provided with an inner terminal 121 formed of a conductor, an insulating member 122, and an outer terminal 123 formed of a conductor. On the outer peripheral surface of the outer terminal 123, a projecting terminal side locking portion 124 is provided. In the sub housing 14, a hole-like communication terminal locking portion 124 is provided that engages with the terminal side locking portion 124 by fitting. Further, in the sub housing 14 as described above, provided are a housing locking portion 143 for primarily-locking with the main housing 15, and a retainer locking portion 144 for secondarily-locking with the retainer 16.

The coaxial cable 12a includes an inner conductor 12a-1, an inner insulator 12a-2, an outer conductor 12a-3, and an outer insulator 12a-4. In step S1, the inner conductor 12a-1, the inner insulator 12a-2, and the outer conductor 12a-3 are respectively exposed. The coaxial cable 12a in this state is passed through the through hole 141 of the sub housing 14. In step S2, the inner terminal 121 is crimped onto the inner conductor 12a-1. In step S3, the insulating member 122 is assembled to the outside of the inner terminal 121, and in step S4, the outer terminal 123 is crimped to the outer conductor 12a-3 so as to cover the outer side of the insulating member 122. By the procedure to this step S4, the communication terminal 12 is connected to the end portion of the coaxial cable 12a.

Finally, in step S5, the coaxial cable 12a is pulled in the direction of the arrow D25, the communication terminal 12 is accommodated in the sub housing 14 and the terminal side locking portion 124 is fitted into the communication terminal locking portion 142. As a result, the sub housing 14 accommodates the communication terminal 12 and locks the communication terminal 12 by the communication terminal locking portion 142.

The sub housing 14 accommodating in this way the communication terminal 12 is accommodated and primarily-locked in the second accommodating chamber 152 at the same time that the crimp terminal 11 connected to the covered electric wire 11a is accommodated and the primarily-locked in the first accommodating chamber 151. As described above, these accommodation and primary locking are performed on the main housing 15 in which the retainer 16 was inserted to the temporarily-locked state, and then the retainer 16 is inserted reaching the fully-locked state.

In the male connector 2 of the present embodiment, a retainer locking portion 244 which is a retainer erect face portion on the inside of the following recess portion 24c is utilized as a portion where the retainer 26 is secondarily-locked for securing the sub housing 24 to the main housing 25. That is, this retainer locking portion 244 is an erect face portion on the inner surface 24c-1 of the recess portion 24c partially recessed from the outer peripheral surface 24a-1 of the male type sub housing 24 having a larger cross section among a male type and a female type of sub housings 24, 14. Further, the retainer locking portion 144 of the female connector 1 is an erect face portion on the inner surface 14c-1 of the recess 14c partially recessed from the extension surface 24a-2 of the outer peripheral surface 24a-1 of the male-type sub housing 24 having a large cross section as described above. Here, the second accommodating chambers 254, 152 of each main housings 25, 15 need a space required for joining the communication terminals 22 and 12 of the male type and the female type. The area of the second accommodating chambers 254 and 152 corresponds to the cross section of the wider one of the male and female sub housings 24, 14. The recesses 24 c, 14 c are portions partially recessed from the outer circumferential surface 24a-1 of the sub housing 24 having a large cross section or extended surface 24a-2 thereof. For this reason, the retainer locking portions 244, 144 must be accommodated in a size required for joining the male type and the female type communication terminals 22 and 12 in the second accommodating chambers 254. That is, it is unnecessary to newly expand the space inside the main housings 25, 15 for the portion where the retainers 26, 16 are secondarily-locked, suppressing an increase in size on the side of main housings 25, 15 for this secondarily-locking structure. As described above, according to the present embodiment, it is possible to suppress the increase in size of the connectors 1 and 2 while suppressing the burden of designing and manufacturing using the sub housings 24 and 14 and the main housings 25 and 15.

Here, the sub-housings 24, 14 of the present embodiment are separately provided with communication terminal locking portions 242, 142 for locking the communication terminals 22, 12, and housing locking portions 243 and 143 for locking the main housings 25, 15. Thus, in the case where the shape or the like of the terminal locking portions 242, 142 is changed, it is possible to minimize an influence on the housing locking portions 243, 143 upon designing or manufacturing and to correspond by changing the communication terminal locking portions 242, 142. As described above, according to the present embodiment, it is possible to further reduce the designing or manufacturing burden.

Further, in the present embodiment, the retainers 26, 16 are configured to be attached in the two stages of the temporarily-locked state allowing accommodation of the communication terminals 22, 12 and accommodation of the sub housings 24, 14 in the main housings 25, 15, and a fully-locked state in which they are secondarily-locked with both of them. According to this embodiment, in the state in which the retainers 26 and 16 are temporarily-locked, the accommodation of the communication terminals 22 and 12 and the accommodation of the sub housings 24 and 14 are performed in random order, and thereafter secondarily-locking can be performed, further suppressing in particular the burden on manufacturing.

Further, in the present embodiment, the sub housings 24, 14 that are large in size and prone to backlash during installation compared with the communication terminals 22, 12 directly attached to the main housings 25, 15 is allowed of backlash in primary locking. Therefore, regarding the structure of primary locking of sub housings 24 and 14, too high locking accuracy is unnecessary, and from this point of view the manufacturing burden can be further suppressed. Regarding the secondary locking as well, the auxiliary pressing by the retainer 26, 16 may suppress backlash, so that the burden of designing and manufacturing can be further suppressed.

It is to be noted that the above-described embodiment merely shows a typical form of the present invention, and the present invention is not limited to these embodiments. That is, within the range not deviating from the essence of the present invention various deformations can be implemented. Even with such a deformation, as far as the configuration of the connector of the present invention is provided, they are of course included in the scope of the present invention.

For example, in the above-described embodiment, as examples of the first terminal and the second terminal according to the present invention, the crimp terminals 21 and 11 connected to the end portions of the covered electric wires 21a and 11a and communication terminals 22 and 12 connected to the ends the coaxial cables 22a and 22a are exemplified. However, the first terminal and the second terminal according to the present invention are not limited to these, and its specific form as long as different types of terminal, is not required.

Further, in the above-described embodiment, as an example of the second terminal according to the present invention, the communication terminals 22, 12, in which only one type is incorporated in the main housings 25, 15 via the sub housings 24, 14 are exemplified. However, the second terminal referred to in the present invention is limited to this. The second terminal referred to in the present invention may be the one, for example, where a plurality of types of terminals such as a communication terminal for a coaxial cable and a ferrule for the optical cable may be assembled via a sub housing, respectively.

Further, in the above-described embodiment, as an example of a main housing referred to in the present invention, the main housings 25, 15 are exemplified in which the first accommodating chambers 252, 151 of the crimp terminals 21, 11 are plural, and the second accommodating chambers 254, 152 of the sub housings 24 is one each. However, the main housing referred to in the present invention is not limited to this, and for example, a plurality of first accommodating chambers and the second accommodating chambers may be provided, or the first accommodating chamber and the second accommodating chamber are provided each in one. The main housing referred to in the present invention can be set as appropriate in in each specific number of the accommodating chamber if at least one of each of them is provided.

Further, in the above-described embodiment, as an example of the retainer referred to in the present invention, the retainers 26, 16 which are individually secondarily-locked in non-immovable manner are exemplified for the crimp terminals 21 and 11 and the sub housings 24, 14 accommodating the communication terminals 22, 12. However, it should be noted that the retainer is not limited to this, but only one of any of the first terminal and the different type second terminal may be secondarily-locked.

### DESCRIPTIONS OF SYMBOLS

1, 2 connector
11, 21 crimp terminal (first terminal)
12, 22 communication terminal (second terminal)
13 frame
14, 24 sub housing
14c, 24c recess
14c-1, 24c-1 inner surface
15, 25 main housing
16, 26 retainer
23 lock lever
124 terminal side locking portion
141, 241 through hole
142, 241 communication terminal locking portion
143, 243 housing locking portion
144, 244 retainer locking portion
151, 252 first accommodating chamber
151a, 252a lance
152, 254 second accommodating chamber
152a, 254a locking hole
153, 253 insertion hole
161, 266 communication hole
162, 262 communication groove
D13, D23 axial direction
D14, D14 cross direction

1. A connector, comprising:
a first terminal;
a second terminal having a terminal type different from that of the first terminal;
a cylindrical sub housing configured to accommodate and lock the second terminal;
a main housing provided with at least one of a first accommodating chamber configured to accommodate and primarily-lock one first terminal and at least one of a second accommodating chamber configured to accommodate and primarily-lock one sub housing; and
a retainer configured to be individually and in a manner avoiding falling-off attached to and secondarily-locked with the main housing, the first terminal housed in the first accommodating chamber and the sub housing accommodated in the second accommodating chamber, wherein
the sub housing is provided with a recess partially recessed from an outer circumferential surface or an extended surface of the outer circumferential surface, the outer circumferential surface having a larger cross section intersecting with an axial direction thereof among a tubular mating sub housing accommodating and locking a mating terminal to be connected with the second terminal and the sub housing, and wherein
the retainer secondarily-locks with an erect face portion on an inner surface of the recess, the erect face portion extending in a cross direction intersecting with the axial direction of the sub housing.

2. The connector according to claim 1, wherein
the sub housing is provided with a terminal locking portion for locking the second terminal, and a housing locking portion for locking the main housing.

3. The connector according to claim 1, wherein
the retainer is configured to be attached to the main housing in two states of a temporarily-locked state allowing the first terminal to be accommodated in the first accommodating chamber and the sub housing to be accommodated in the second accommodating chamber, and of a fully-locked state in which the retainer secondarily-locks the first terminal and the sub housing.

4. The connector according to claim 2, wherein
the retainer is configured to be attached to the main housing in two states of a temporarily-locked state allowing the first terminal to be accommodated in the first accommodating chamber and the sub housing to be accommodated in the second accommodating chamber, and of a fully-locked state in which the retainer secondarily-locks the first terminal and the sub housing.
